(19) United States
(12) Patent Application Publication
(10) Pub. No.: US 2004/0139066 A1
(43) Pub. Date: Jul. 15, 2004

(54) Job guidance assisting system by using computer and job guidance assisting method

(76) Inventors: Takashi Yokohari, Iwai (JP); Hiroyuki Nemoto, Tokyo (JP); Hiromitsu Tokisue, Chiyoda (JP); Ichiro Nishigaki, Ishioka (JP); Yuki Shimizu, Chiyoda (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/630,709

(22) Filed: Jul. 31, 2003

(30) Foreign Application Priority Data
Jan. 14, 2003 (JP) 2003-005208

(51) Int. Cl. G06F 17/30

(52) U.S. Cl. 707/3

(57) ABSTRACT

A system for guiding and assisting a job for producing document with using a computer comprises, a similarity estimation portion for executing build-up of a relationship between a document to be produced and a reference material(s) which is/are referred to for producing the document, and a referring record database for memorizing the relationship therein. The relationship between the document to be produced and the reference materials(s), which are memorized in the referring record database, is searched out by means of a referring record search portion. Reference relationship between the document to be produced and the reference material(s) is searched out by means of a document production record search portion. The similarity estimation portion, the reference record search portion, and the document production search portion are made of software programs, which are stored in a computer or a server.

### BACKGROUND OF THE INVENTION

The present invention relates to a system for making assistance with an aid of job guidance information by using a computer, and a job guidance assisting method.

An example of a document management within a conventional work guidance assisting system is disclosed, for instance, in Japanese Patent Laying-Open No. 2002-207726<JP-A 207726/2002>. In this publication, for the purpose of achieving extraction of a document relating to that of an operation target, but without conducting pre-operations, such as, sorting and/or building up relationship on documents, etc., thereby enabling them to be referred easily, it is described that the record information of operations made on the documents, which is produced by means of an operation record management portion, is compared to the record information of the documents of operation target, so as to extract a document having a high possibility in relevancy thereof, thereby enabling to refer the contents of those documents.

Also, in Japanese Patent Laying-Open No. Hei 10-334128<JP-A 334128/1998>, it is described to manage reference materials by referring thereto, for achieving design review at high accuracy, but without omission of checking thereon, thereby enabling a result of review to be owned in common, and maintaining the security thereof, as well.

In such the document management system as described in the Japanese Patent Laying-Open No. 2002-207726 mentioned above, although the related document can be extracted from the operation records, however, since attention is paid only upon the operation records, therefore a possibility is still high that a plural number of documents are opened at the same time, which have no relationship thereto. As a result, sufficient consideration is not paid upon an aspect of building up relationship between the reference information thereof, in particular, such as, when simply looking through the document as information, for example, or also when completing one (1) piece of document, time-sequentially through a plural number of operations thereon.

In the system described in Japanese Patent Laying-Open No. Hei 10-334128 (1998), however it is necessary to set up a user name, a step name of development, a step name of design review, a rough classification, a middle classification, and a detailed classification, etc., in advance. Further, if data increases in an amount thereof, it is not enough to manage with the set-up, in particular, only with such the initial set-up condition as was mentioned, and there is a possibility of causing a situation where change must be made on that set-up condition.

### BRIEF SUMMARY OF THE INVENTION

According to the present invention, for dissolving such the drawbacks of the conventional arts mentioned above, an object thereof is to provide a job guidance and assistance system and a job guidance and assistance method, in particular, in a job using a computer while using a plural number of materials therewith, wherein a necessary document can be searched out, effectively, from the plural number of those materials. Other object according to the present invention is, in such the job with using the computer, to achieve an effective manner for building up a mutual relationship between the materials, thereby to be used in production of documents. Further other object is, according to the present invention, to guide and assist a job using a computer therewith. And, according to the present invention, the object is to accomplish at least one of those objects mentioned above.

According to the present invention, for accomplishing the above object mentioned above, there is provided a job guidance and assistance system for guiding and assisting a job of producing a document with using a computer, comprising: a referring record database for memorizing therein a relationship built up between a document to be produced and a reference material, which is referred to for producing the document; a referring record search means for searching out the relationship between-the-document to be produced and the reference material, which is memorized in the referring record database; and a document production record search means for searching out a reference relationship between the document and the reference material.

And, according to the present invention, preferably, the job guidance and assistance system with using a computer, as described in the above, further comprises a similarity estimation means for executing said building up of the relationship, wherein said estimation means also executes building-up of a relationship upon basis of at least one of comparisons on a word appearing in the document to be produced and the reference document, at a rare frequency thereof, a category of the document to be produced and the reference document, and a referring time or referring frequency of the document to be produced and the reference document. Also, preferably, the job guidance and assistance system with using a computer, as described in the above, further comprises a display means for display the relationship thereon. Further, according to the present invention, preferably, the job guidance and assistance system with using a computer, as described in the above, wherein said similarity estimation means estimates that the reference material is opened, if the reference material is opened during when the document to be produced is opened. And further, according to the present invention, preferably, the job guidance and assistance system with using a computer, as described in the above, wherein all of said similarity estimation means, said refer record search means and said document production record search means are made of software programs.

Moreover, according to the present invention, for accomplishing the other object, there is provided a job guidance and assistance method with using a computer, for guiding and assisting job for producing a document, comprising the following steps of: accumulating a document to be produced and a reference material, which is referred to for producing the document, into a database, in a hierarchical manner, while establishing a relationship therebetween; and displaying the hierarchical relationship. And, according to the present invention, preferably, the job guidance and assistance method with using a computer, as described in the above, wherein the relationship is built up between the document to be produced and the reference document, by making comparison on at least one of a word appearing in the document to be produced and the reference document, at a rare frequency thereof, a category of the document to be produced and the reference document, and a referring time or referring frequency of the document to be produced and the reference document, and it is searchable when producing a document newly or renewing an existing document, upon basis of the relationship built up. Also, preferably, according to the present invention, the job guidance and assistance method with using a computer, as described in the above, wherein the building up of relationship on the word appearing at rare frequency is executed with using a plural number of words, in an order starting from a word, which appears in the document to be produced at the least.

### BRIEF DESCRIPTION OF THE SEVERAL VIEWS OF THE DRAWING

FIG. 1 is a block diagram for showing an embodiment of a work guidance/assistance system, according to the present invention;

FIG. 2 is a view for explaining the embodiment of the work guidance/assistance system, according to the present invention;

FIGS. 3 to 5 are views for explaining a manner of building up relationships among reference materials;

FIGS. 6 and 7 are views for showing an example of a display screen of a search result thereon; and

FIGS. 8 and 9 are views for showing an example of the display screen of a parentage relationship among the documents.

### DETAILED DESCRIPTION OF THE INVENTION

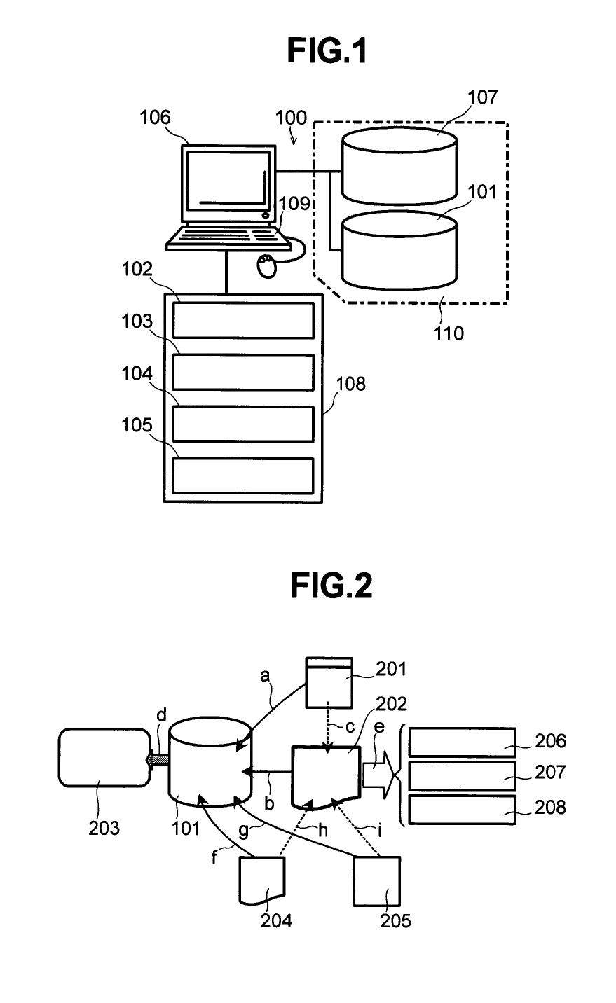

Hereinafter, embodiments according to the present invention will be fully explained, by referring to the attached drawings. FIG. 1 is a block diagram of showing an example of the job guidance/assistance system 100, according to the present invention. The job guidance/assistance system 100 for assisting a job of producing documents comprises: a computer or a server 108; an input device 109 for inputting data into the computer or the server 108; and an output device for outputting documents and/or data, which are produced and/or searched through the computer or the server 108, etc. In addition thereto, to the computer or the server 108 is provided at least one (1) set or more of memory calculation means 110, storing a referring record information database 101 for storing referring records therein, and a document database 107 for storing the documents produced and the reference materials therein. The input device 109 and the output device 106 are used for displaying and/or operating the reference materials, on the job with using a computer, in particular, when conducting the job, such as, production of documents and production of printed data, and/or when conducting a job for producing a form to register a WEB page on the Internet, for example. According to the present embodiment, though the memory means 110, which stores the databases 101 and 107 therein, is additionally provided with the computer or the server 108, however it is also possible for those databases to be stored within the computer or the server 108.

The computer or server 108 comprises: an analogy estimation portion 102, for estimating analogy by referring to the data stored in the referring record information database 101, concerning the documents or the like, which are under production; a referring record search portion 103, for extracting a target referring record from the referring record information database 101; a document production record search portion 104, for extracting the parentage relationship among the documents, the details of which will be described later, upon basis of the referring records among the documents, which are stored in the referring record information database 101; and a search result output portion 105 for displaying the search result of the referring record and/or the document production record, for a worker. Those analogy estimation portion 102, the referring record search portion 103, the document production record search portion 104 and the search result output portion 105 may be built up by using the same CPU or different CPUs provided separately. However, each function of those portions 102 to 105 is carried out by means of software program.

FIG. 2 shows the works, diagrammatically, which are conducted by using the job guidance/assistance system 100 shown in FIG. 1. Sometimes, in the job with using the computer, a business document 202 is produced, such as, a design plan and/or a report, or the like, for example, by searching a manual and/or other reference materials 204, etc. In such the instance, if a similar document was already produced in the past, it is possible to improve efficiency on production of materials, through speedy taking-out of the other materials, or the like, which were referred at that time.

Then, the produced document 202 is converted into electronic data, to be memorized into the memory means. In that instance, a name of the document or the like 204, and/or a name of tool or the like 205, such as, a name of URL (Uniform Resource Locator: i.e., an address) of the WEB page 201 or the software program that was used, for example, which were referred to when producing the document (steps c, i, and h), is/are registered into the referring record information database 101 (steps a, b, f and g), together with information of the produced document 202. This registration is carried out (step e) when the produced document 202 is outputted to a hard disk, a printer, a network, etc., and in more details, it is executed at the timing, such as, a file reservation 206, a printing 207, a transmission 208 of a form content from the WEB page 201, etc., for example. However, if it is registered at the timing when an application program is finished, being used for producing the document, etc., there may occur a possibility that the document aimed to be registered is unclear. Then, it is registered at the timing when a user provides any kind of an output. A result obtained by referring to or searching out the referring record information database 101 (step d) is displayed on the output means 106.

Those having high relevancy with the data, which are outputted, are extracted, automatically, as the items to be registered in the referring record information database 101. In this instance, weighting is made depending on fact that the following(s) are satisfied or not:

(1) similarity of the documents, upon the basis of the frequency of appearance of rare words;

(2) similarity of the documents in the meanings thereof, depending on the categories of thereof; such as, being a specification or a catalogue;

(3) overlapping on dates and times when they are opened at the same time, in particular, when producing the documents, and a total accumulated time thereof; and

(4) a frequency; i.e., the number of times of opening the documents when completing one (1) document. About the items mentioned above for the document 202 to be newly produced, the search is made on the similarity information which is stored in the referring record information data base 101, and thereby displays the document(s) and the like to be referred to. Hereinafter, explanation will be given about the operation of the similarity estimation portion 102, for extracting data having high relationship with the date outputted, automatically.

Examples of the frequency of appearance on words appearing within a document will be shown in TABLE 1, which is used for building up a relationship between the document 202 under production and the plural number of reference materials 203, which were referred at that time.

TABLE 1

| | Target | Reference | Reference | Reference |
|---|---|---|---|---|
| Word | Document | Material 1 | Material 2 | Material 3 |
| aaa | 10 | 12 | 10 | 10 |
| bbb | 8 | 6 | 8 | 9 |
| ccc | 8 | 8 | 5 | 6 |
| ddd | 7 | 2 | 0 | 8 |
| eee | 7 | 1 | 3 | 4 |
| fff | 7 | 2 | 4 | 3 |
| ggg | 6 | 1 | 2 | 7 |
| kkk | 6 | 1 | 2 | 3 |
| . . . | . . . | . . . | . . . | . . . |
| . . . | . . . | . . . | . . . | . . . |
| xxx | 1 | 0 | 1 | 2 |
| yyy | 1 | 0 | 0 | 1 |
| zzz | 1 | 0 | 0 | 1 |

Herein, words appearing in the target document 202, i.e., the document under production, are listed up from the top, in the order of the height of the frequency of appearance thereof. There cannot be found a meaningful difference among the frequencies of the reference materials 1 to 3, in particular, relating to the words showing the high frequency of appearance, such as, “aaa” and “bbb”, for example. On the contrary to this, paying attention onto the words having a low frequency of appearance in the reference materials 1 to 3, such as, “xxx”, “yyy” and “zzz”, for example, it is appear that the reference material 3 appears much more in times, comparing to those reference materials 1 and 2. In such the case, it is decided that the relevancy is high between the target document and the reference material 3. Also, in the reference material 2, since the word “xxx” of low appearance frequency appears in the target document, therefore it is decided to have a relevancy.

Explanation will be given in more details, about this setting of relevancy. For example, three (3) words, which are low in a rank of the frequency of appearance are taken out, within the target document, and it is studied if they appear or not in each of the materials. In the case of the reference material 1, any one of the three (3) words does not appear, therefore a degree of relevancy is 0% from a viewpoint of the appearing words. In the case of the reference material 2, since only one word, “xxx” appears, then a degree of relevancy is 33%. In the case of the reference material 3, all of the three (3) words of the low rank appear, and therefore the degree of relevancy is estimated to be 100%.

The similarity in the meaning of the document is determined by means of classification, with an aid of category. It is assumed that the document 202 under production belongs to any one of the categories, such as, the “specification”, “estimate”, “catalogue” and “purchasing specification”, for example. However, it is assumed that the referring record information database 101 itself has no such an attribute or property in the document category. In this instance, search is made on the item(s), which is/are coincident with, between the document 202 under production and a plural number of data stored in the referring record information database 101.

As an example, a title of the document is used as specific information thereof. If the “specification” is contained in the title of the document 202 under production, then the data containing the “specification” therein is selected among the data stored in the referring record information database 101. When compiling the existing document, the document is selected, which is coincident with in the name of a class of the folder storing that document therein, in a system where the folders are stored in a hierarchical manner.

Further, the document 202 under production is classified among; such as, a document produced with an aid of word processor software, a calculation spread sheet, a HTML file, or other kind of data file, for example. Using of those classifications, the data having the same classification, as the document 202 under production has, is selected from the data of the reference materials stored in the referring record information database 101. In this instance, a ratio of the item numbers, which are coincident with between the document 202 under production and the reference materials, is used as a degree of the relevancy.

Now, it is assumed that 100 pieces of the items among those of the document 202 under production are appearing on the data of plural number of materials, which are stored in the refer record information database 101. In this instance, for any one of the reference materials, it is estimated to be 50% in the degree of relevancy if 50 items appear. Or, simplifying much more, if there are data containing the “specification” in the title of the document 202 under production, the data containing that “specification” in the file name are highly classified in the relevancy among the reference materials, which are opened when producing that document 202. In the case of compiling the existing documents, the search is made by using the name of the folder, in which each document is stored, as a keyword. Alternately, in the similar manner to that when making search on the referring record information database 101, it is also possible to use the classifications, such as, “word processor document”, “calculation spread sheet”, “HTML file” and other data files, etc.

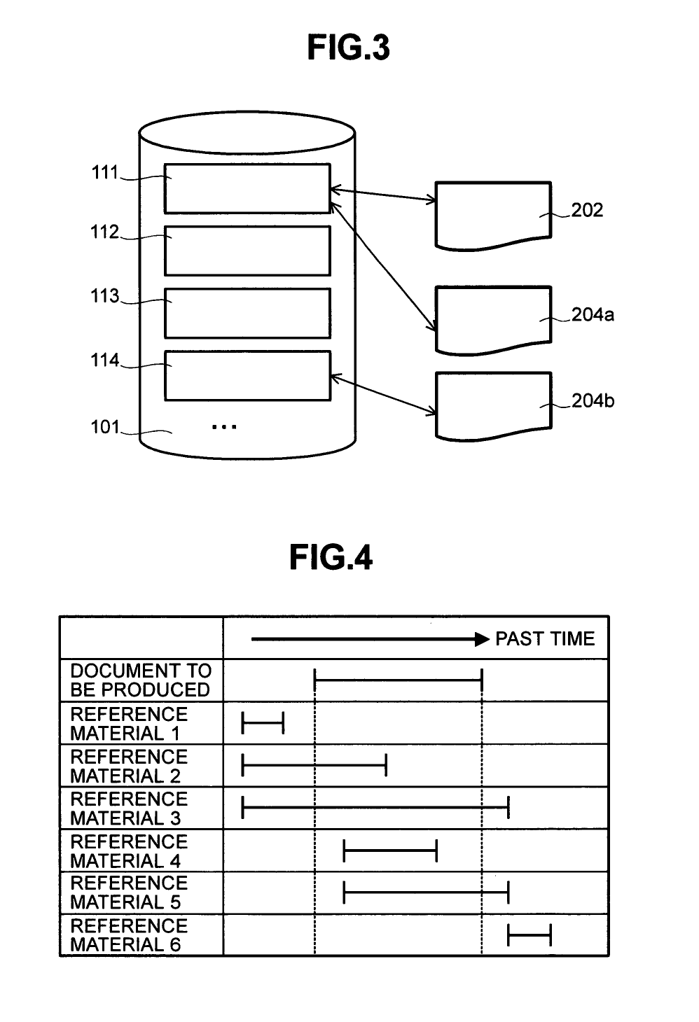

In the case where the referring record information database 101 has an attribute or property of the document category, it is enough to make search on coincidence in the category between the document 202 under production and the reference materials 204. The category, to which the document 202 under production belongs, is searched out from the referring record information database 101. And, the document category at the highest in the possibility thereof is obtained, and the degree of relevancy is estimated from the coincidence of the reference materials 204, which are opened at that time, with that category. FIG. 3 shows a method for estimating a similarity in the meaning between the document 202 under, production and the reference materials 204.

In FIG. 3, the document data stored in the referring record information database 101 is classified into the categories, such as, the specification 111, the estimate 112, the catalogue 113, the purchase specification, etc. The category of the document 202 under production is the specification 111, and the category of the first reference material 204a is also the specification 111. On the contrary to this, the category of the second reference material 204b is the purchase specification 114. In such the case, the degree of relevancy with the document under production is, for example, 100% with the first reference material 204a, and 0% with the second reference material 404b.

Relationship is build up in the following manner, between the time when the document 202 under the production is produced and that when the reference material 204 is opened. In such the instance, there is a high possibility that erroneous information is related with, if decision is made upon only the basis of a result of operation of one (1) time, during the document production. Then, the estimation is made on the accumulation time of a plural number of operations. The reason of this lies in that, since there is a possibility of opening a plural number of the documents and the reference materials at the same time, but being different in the purpose thereof, in only one (1) time of the operation in the document producing, and it is not always possible to decide to have the high relevancy, even if those documents are opened within the same time band.

FIG. 4 shows an example of the relationship between the production time of the document 202 under production and the time when the reference materials 204 are opened. This is an example, where the document is produced while using six (6) reference materials opened therewith. Dividing the time into zones, such as, “before production”, “during production”, and “after production”, for example, makes the materials different in use modes thereof, such as, the material which is used during all of those zones, that which is used only each of the zones, and that which is used during the time bridging over two (2) zones, etc. The reference material 1 is used only before the production, and the reference material 6 is used only after the production, but they are not opened at the same time to the document 202 under production. Accordingly, the relation time is zero (0). With the reference materials 2 to 5, there is a time when they are opened at the same time to the document 202 underproduction, and therefore the time when they are opened together with the document 202 under production is made to be the relation time thereof.

If the document 202 under production was used also in the past, the relation time at the present is added to the past relation time. When the document is produced newly, the relation time obtained at the present is an initial value thereof. If producing the document 202 under production is finished by only one (1) time of the operation, there may be a possibility of adding uncertain information thereto. However, there can be obtained such information therefrom, that other material(s) was/were opened when producing the document under production. But, regarding the relation time when the operation is less in the number of times thereof, it is possible to adjust the relationship with the document to be produced, by lowering the weighting of the information thereof.

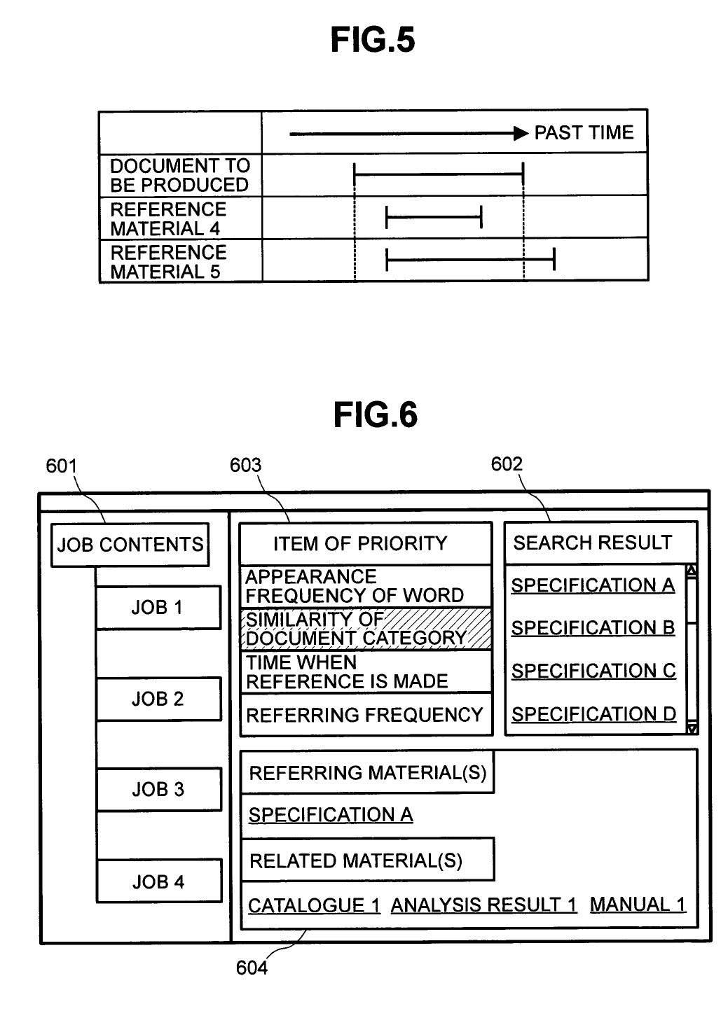

The degree of relevancy can be also estimated between the document 202 under production and the reference materials 204, through other method. This is a method of counting up the frequency thereof; i.e., how many times the reference is made to the materials 204 until the time when the document 202 under production is completed. Herein, the reference material, which is opened after opening the document 202 under production, is defined “refereed to”. By referring to FIG. 5, explanation will be made on the manner of counting the referring frequency. The reference materials 4 and 5 are opened after opening of the document 202 underproduction. In this case, they are counted to be “referred to”. However, it is unclear whether the reference materials 4 and 5 contribute or not, in particular, to producing the document 202 under production. There can be a possibility of opening the file only to look through the contents therein. For reducing the uncertainty on the relevancy, it is preferable to accumulate the referring records.

Since the degree of relevancy is determined between the document 202 under production and the reference materials 204, from the respective viewpoints mentioned above, hereinafter, explanation will be given about a method of producing the job guidance information, which is produced by using the referring record data, which are stored in the referring record information database 101. In the referring record information database 101 are stored the data of the documents produced in the past, including data for printing and data sent to WEB pages, and also the information of the reference materials which are related thereto. As the information of the referencematerials, such as, a storage location (i.e., a directory) and the material itself can be listed up, for example.

In the jobs, such as, the work of producing the document newly, the work of renewing of or adding onto the existing document, the work of producing the document for use of printing, or the work of inputting and sending to form to the WEB, etc., search is made on the jobs of the past, which are similar to each of the works stored within the referring record information database 101. Following an instruction made by user, the referring record search portion 103 conducts search on the referring record information database 101, and a result of that search is displayed on the search result output portion 105 in the form of a list. The user can pick up the information of the reference materials 204, which are related to the searched works in the past, to display thereon. With this, the user can find out the information of the necessary reference materials, easily.

In case of renewing the document, which was already produced, it is possible to omit the inputting, etc., of the keywords for searching out. In cases other than that, the keywords for searching are inputted. As such the keywords for the search, the name of work, the category of the document to be produced, etc., can be listed up, as examples thereof. In order to determine an order on the candidates of reference materials 204 to be outputted, it is possible to designate the weighting of the degree of relevancy. As the weighting can be included, such as, the frequency of appearance of the word, the similarity in the meaning of documents, the relation time, and the referring frequency, for examples. The weighting is carried out, for example, by multiplying an appropriate coefficient on taking sum of products, i.e., the frequency of appearance of the word, the similarity in the meaning of documents, the relation time, or the referring frequency, thereby obtaining sum of products thereof.

In FIG. 6 is shown a result of the search giving priority on the degree of approximation in the meaning of the document 202 under production. FIG. 6 shows an example of a screen displayed on the output device shown in FIG. 1. Herein, the coefficient of weighting is made large, in particular, relating to the similarity in the meaning of document. On the left-hand side on the screen, the job contents 601 are displayed in the form of the structure, such as, a tree. The job contents include, for example, production of the specification, production of the estimate, production of the purchase specification, etc. By selecting one (1) from the contents of jobs shown herein, and designating an item 603, on which the priority was given, when conducting the search shown in an upper portion of the screen, the reference materials 204 are displayed on the right-hand side in an upper portion of the screen, which are seemed to be necessary for the job at present, as a result of the search.

A search priority item 603 is displayed, while being treated with the highlighting processing, such as, the reversing processing, or the meshing (or shading) processing, for example, thereby to be noticed easily. In this FIG. 6, the degree of similarity in the document categories is selected to be the contents having priority thereon. The order in aligning the search result 602 is determined in accordance with the priority contents 603.

The center and the right-low portion of the screen makes up a display 604, on which the relationship of the reference materials are displayed, being selected by the user among plural number of the reference materials, which are extracted through the search. In FIG. 6, there is shown the condition that the specification A is selected, which had the highest degree in coincidence thereof. Upon selection of the reference materials, the related materials are displayed at the same time. Designating them through the file names and the URT thereof enables to access the reference materials or the related materials, immediately.

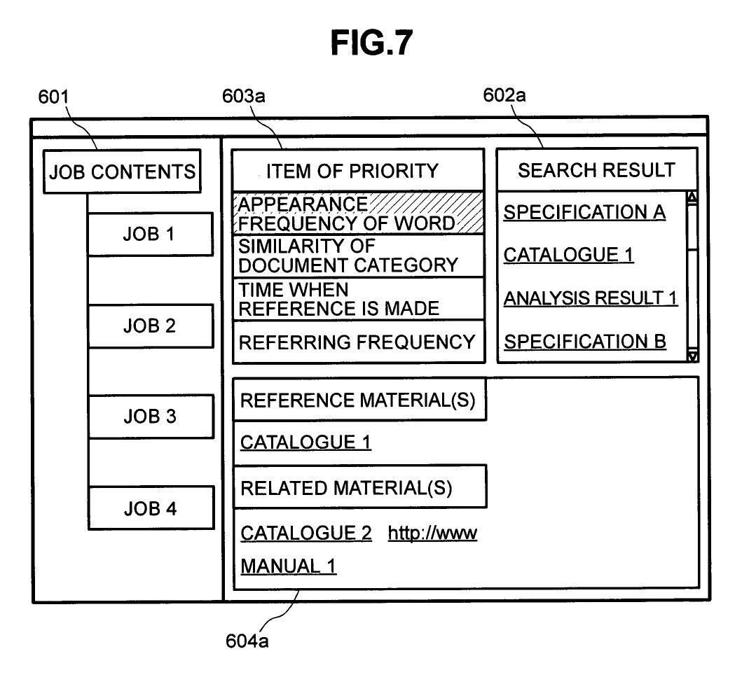

FIG. 7 shows other example of the screen display when the frequency of appearance on word is selected to be the priority item 603a. The display of the job contents 601 is same to that shown in FIG. 6. Accompanying the change of the priority item 603a into the frequency of appearance on word, also the search result is changed over. On the display portion 604a is displayed a relationship of the catalogue, in particular, in the case where the user selects the catalogue 1 among the reference materials, which are displayed on the search result 602a.

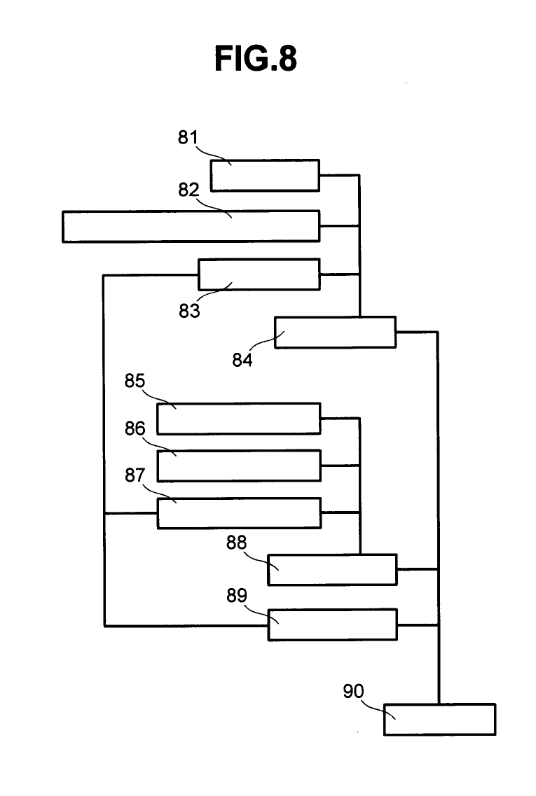

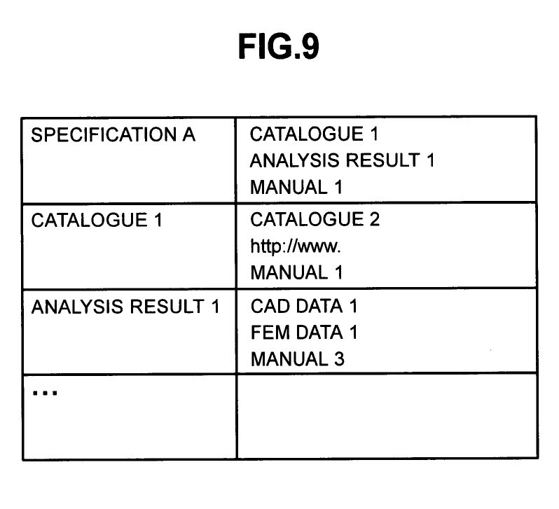

If extracting and displaying a parent-child (parental) relationship between the documents produced upon the basis of information of the reference materials, which are accumulated in the referring record information database 101, it is easy for the user to understand the relationship between the documents, which are produced in the past. A representative example of this will be explained by referring to FIGS. 8 and 9. Those FIGS. 8 and 9 are figures to be shown on the same screen, and in particular, FIG. 8 shows the right-hand side one, while FIG. 9 the left-hand side one. The document production record search portion 104 shown in FIG. 1 retraces the reference material information, which is added to each of the documents as the attribute or property thereof, by using the referring record information database 101, thereby extracting the mutual referring relationship between the documents.

In those figures, search is conducted by giving the priority on the appearance frequency of word. The search result 602a of FIG. 7, which is obtained by giving the priority on the appearance frequency, and also the relationship 604 among the respective reference materials, which are extracted as the result of that search, are shown in the form of a table in FIG. 9. And, FIG. 8 is an illustration of the referring relationship, in particular, about the “specification A” shown in this list.

When producing the specification A:90, the catalogue 1:84, the analysis result 1:80 and the manual 1:83 are referred to. The catalogue 1:84 is produced, by referring to the catalogue 2:81, the Internet address 82, and the manual 1:83. In the similar manner, the analysis result 1:88 refers to the CAD data 1:85, the limited element analysis data 1:86, and the manual 3:87. The manual 1:83 and the manual 3:87 are related with each other. With such visualization thereof in this manner, it is possible to indicate the information necessary for producing the document under production to the user, quickly.

Though description was given only about the example, where the document to be produced is stored into a hard disc in the form of the file format, in the embodiment mentioned above, however according to the invention, the document can be also treated in the similar manner as was mentioned in the embodiment described in the above, in particular, in the case, such as, when sending the data to a printer, or when sending the contents to the WEB page, for example.

By building up a relationship between the materials, which are referred to in the job of document production, when executing a plural number of jobs in parallel with using a computer, the necessary document can be extracted with high efficiency from the materials in the plural number thereof. Also, it is possible to improve the efficiency of the production of document, in the jobs using the computer therewith.

The present invention may be embodied in other specific forms without departing from the spirit or essential feature or characteristics thereof. The present embodiment(s) is/are therefore to be considered in all respects as illustrative and not restrictive, the scope of the invention being indicated by the appended claims rather than by the forgoing description and range of equivalency of the claims are therefore to be embraces therein.

What is claimed is:

1. A job guidance and assistance system for guiding and assisting a job of producing a document with using a computer, comprising:
a referring record database for memorizing therein a relationship built up between a document to be produced and a reference material, which is referred to for producing the document;
a referring record search means for searching out the relationship between the document to be produced and the reference material, which is memorized in the referring record database; and
a document production record search means for searching out a reference relationship between the document and the reference material.

2. The job guidance and assistance system with using a computer, as described in the claim 1, further comprising a similarity estimation means for executing said building up of the relationship, wherein said estimation means also executes building-up of a relationship upon basis of at least one of comparisons on a word appearing in the document to be produced and the reference document, at a rare frequency thereof, a category of the document to be produced and the reference document, and a referring time or referring frequency to the document to be produced and the reference document.

3. The job guidance and assistance system with using a computer, as described in the claim 1, further comprising a display means for display the relationship thereon.

4. The job guidance and assistance system with using a computer, as described in the claim 2, further comprising a display means for display the relationship thereon.

5. The job guidance and assistance system with using a computer, as described in the claim 2, wherein said similarity estimation means estimates that the reference material is opened, if the reference material is opened during when the document to be produced is opened.

6. A job guidance and assistance method with using a computer, for guiding and assisting job for producing a document, comprising the following steps of:
accumulating a document to be produced and a reference material, which is referred to for producing the document, into a database, in a hierarchical manner, while establishing a relationship therebetween; and
displaying the hierarchical relationship.

7. The job guidance and assistance method with using a computer, as described in the claim 6, wherein the relationship is built up between the document to be produced and the reference document, by making comparison on at least one of a word appearing in the document to be produced and the reference document, at a rare frequency thereof, a categories of the document to be produced and the reference document, and a referring time or a referring frequency of the document to be produced and the reference document, and it is searchable when producing a document newly or renewing an existing document, upon basis of that relationship built up.

8. The job guidance and assistance method with using a computer, as described in the claim 7, wherein the relationship built up by the word appearing at rate frequency is executed with using a plural number of words, in an order starting from a word, which appears in the document to be produced, at the least.

9. The job guidance and assistance system with using a computer, as described in the claim 2, wherein all of said similarity estimation means, said refer record search means, and said document production record search means are made of software programs.
